(19) United States
(12) Patent Application Publication
(10) Pub. No.: US 2011/0097010 A1
(43) Pub. Date: Apr. 28, 2011

(54) Method and system for reducing noise in images in video coding

(76) Inventors: Jian Wang, Sunnyvale, CA (US); Zhang Yong, Santa Clara, CA (US)

(21) Appl. No.: 11/638,317

(22) Filed: Dec. 13, 2006

(51) Int. Cl. G06K 9/40

(52) U.S. Cl. 382/261

(57) ABSTRACT

A method, system and computer program product for filtering noise from an image is disclosed. The image includes a plurality of pixels. A category for each of the plurality of pixels in the image is determined. Thereafter, a filter value for each of the plurality of pixels is determined based on the category of each of the plurality of pixel. Finally each of the plurality of pixels is modified based on the filter value of each of the plurality of pixels.

### RELATED APPLICATION

This application is related to the following application which is hereby incorporated by reference as if set forth in full in this specification: Co-pending U.S. patent application Ser. No. (TBD), entitled ‘Method and System for Filtering Images in Video Coding’, filed herewith and bearing attorney docket number WWCI-022-999.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The invention relates generally to the field of video coding. More specifically, the invention relates to a method, system and computer program product for filtering an image using an adaptive edge-based noise reducer.

### BACKGROUND OF THE INVENTION

An image is typically represented by a two-dimensional array of digital values. A digital value of the image is called a picture element or a pixel. Images are created by various devices, such as digital cameras, scanners, coordinate-measuring machines, seismographic profiling and the like. Video coding technology has been widely used in the storage and transmission of images. Various compression tools are used for compressing the images before transmission. The compression tools are defined by various international standards. Examples of international standards include, but are not limited to, MPEG2, H.263, MPEG4 and H.264. H.264 is the latest international video standard. The compression tools of all those standards do not consider the noises, for example, white Gaussian noise, random noise, and salt and pepper noise, introduced in the images. The presence of noise not only degrades the image quality, but also lowers encoding performance. Thus to improve compression efficiency, removal of noise is desired.

Video compression algorithm mainly includes three processes: Encoding, Decoding and Parsing. To smoothen the compression process, filtering of the image is done prior to the encoding process. However, filtering needs to be done in such a way that, while noise is removed, the details and textures in the image should remain visually intact. Currently available pre-processing systems include simple low-pass filters, such as mean filter, median filter and Gaussian filter, which keep the low frequency components of the image and reduce the high frequencies. U.S. Pat. No. 6,823,086 discloses a system for noise reduction in an image using four 2-D low-pass filters. The amount of filtering is adjusted for each pixel in the image using weighting coefficients. Different filters are used as the low-pass filters, for example, 2D half-band 3×3 filter and 5×5 Gaussian filters. The patent does not provide clear information for the calculation of the weighting coefficients. Another U.S. Pat. No. 5,491,519, discloses a method for adaptive spatial filtering of a digital video signal based on the frame difference. The frame difference is computed without motion compensation. As such, the method causes the moving contents of digital video signal to blur.

Yet another low-pass noise filter used is Gaussian filter. U.S. Pat. No. 5,764,307 discloses a method for spatial filtering of video signal by using a Gaussian filter on displaced frame difference (DFD). The method has high complexity and requires multiple-pass processing of the source video. Another U.S. Pat. No. 6,657,676, discloses a spatial-temporal filter for video coding. A filtered value is computed using weighted average of all pixels within a working window. This method also has very high complexity.

Low-pass filters, used in prior art for filtering images, remove high frequencies within frames. High frequencies are important for producing sharpness of the image. Thus, removal of high frequencies causes blurring of edges in the image. Hence, a spatial/temporal filter is desired to remove noise formation within each frame while keeping the visually-important high frequency signals. Further, it is desired to incorporate local features into filtering process to significantly attenuate noise and improve coding efficiency. Moreover, it is desired to preserve boundaries and details in the image during filtering.

### SUMMARY

An objective of the invention is to provide a spatial/temporal filter to remove noises and non-noticeable high frequency signals in an image.

Another objective of the invention is to provide an adaptive method for filtering the image to incorporate local features into filtering process to significantly attenuate noise and improve encoding efficiency.

Yet another objective of the invention is to improve visual quality and reduce bit-rate for an encoding system.

Still another objective of the invention is to provide a method for filtering the image while preserving boundaries and details in the image.

To achieve the above-mentioned objectives, the invention provides a method, system and computer program product for filtering an image. The image, including a plurality of pixels, is input into a pre-processing filter. First, a category for each of the plurality of pixels is determined. Thereafter, for each of the plurality of pixels, a filter value is determined based on the category of each of the plurality of pixels. Finally, each of the plurality of pixels is modified based on the filter value of the each of the plurality of pixels.

In another embodiment of the invention, the computer program product including a computer usable medium having a computer readable program code embodied therein for filtering an image determines a category for each of the plurality of pixels. Further, the computer readable program code for filtering the image determines a filter value for each of the plurality of pixels based on the category determined for each of the plurality of pixels. Finally, the computer readable program code for filtering the image modifies each of the plurality of pixels based on the filter value of each of the plurality of pixels.

In yet another embodiment of the invention, the system for filtering an image includes a pixel category determiner, a filter value determiner and a pixel modifier. The pixel category determiner determines a category for each of the plurality of pixels. The filter value determiner then determines the filter value for each of the plurality of pixels based on the category of each of the plurality of pixels. Finally, the pixel modifier modifies each of the plurality of pixels based on the filter value of each of the plurality of pixels.

The pre-processing filter helps to remove noises and high frequency signals in the video images. The method for category determination incorporates local features of the pixels in the image and thus, significantly attenuates the noise and improves the encoding efficiency. Further, incorporating local features into the filtering process improves the visual quality, bit-rate saving and an overall enhancement in the coding efficiency.

### BRIEF DESCRIPTION OF THE DRAWINGS

The present invention will now be described with reference to the accompanying drawings, which are provided to illustrate various example embodiments of the invention. Throughout the description, similar reference names may be used to identify similar elements.

FIG. 1 illustrates an environment in which various embodiments of the invention may be practiced;

FIG. 2 is a block diagram of a pre-processing filter, in accordance with an embodiment of the invention;

FIG. 3 is a flowchart, illustrating a method for filtering an image, in accordance with various embodiments of the invention;

FIGS. 4a, 4b, 4c and 4d depict a flowchart, illustrating a method for filtering a pixel of an image, in accordance with an embodiment of the invention;

FIG. 5 illustrates an exemplary embodiment of a method for filtering a pixel of an image in an 3×3 neighboring window, in accordance with an embodiment of the invention; and

FIGS. 6a and 6b is an exemplary table and an exemplary graph illustrating thresholds for edge detection, in accordance with various embodiments of the invention.

### DESCRIPTION OF VARIOUS EMBODIMENTS

Various embodiments of the invention provide a method, system and computer program product for filtering an image. An image is input into a pre-processing filter. The image includes a plurality of pixels. First, a category for each of the plurality of pixels is determined. Thereafter, for each of the plurality of pixels, a filter value is determined based on the category of each of the plurality of pixels. Finally, each of the plurality of pixels is modified based on the filter value of the each of the plurality of pixels.

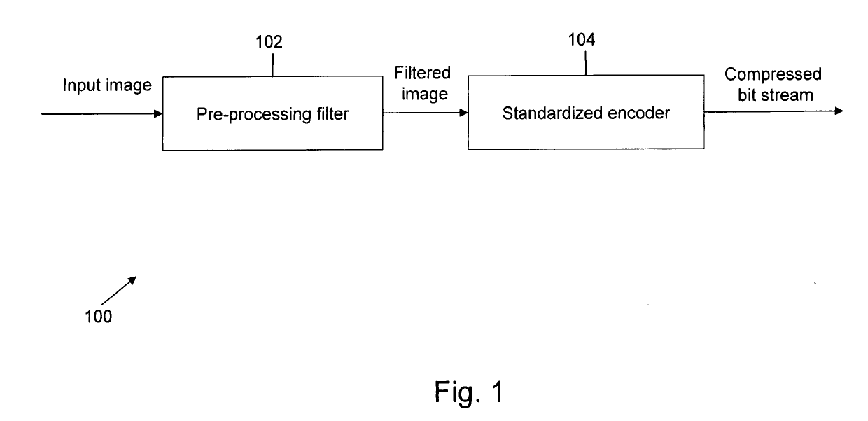

FIG. 1 depicts an environment 100 in which various embodiments of the invention may be practiced. Environment 100 includes a pre-processing filter 102 and a standardized encoder 104. An image is input into pre-processing filter 102. The image includes a plurality of pixels. Each pixel of the plurality of pixels includes information such as color values, chrominance and luminance values and the like. Pre-processing filter 102 filters the image.

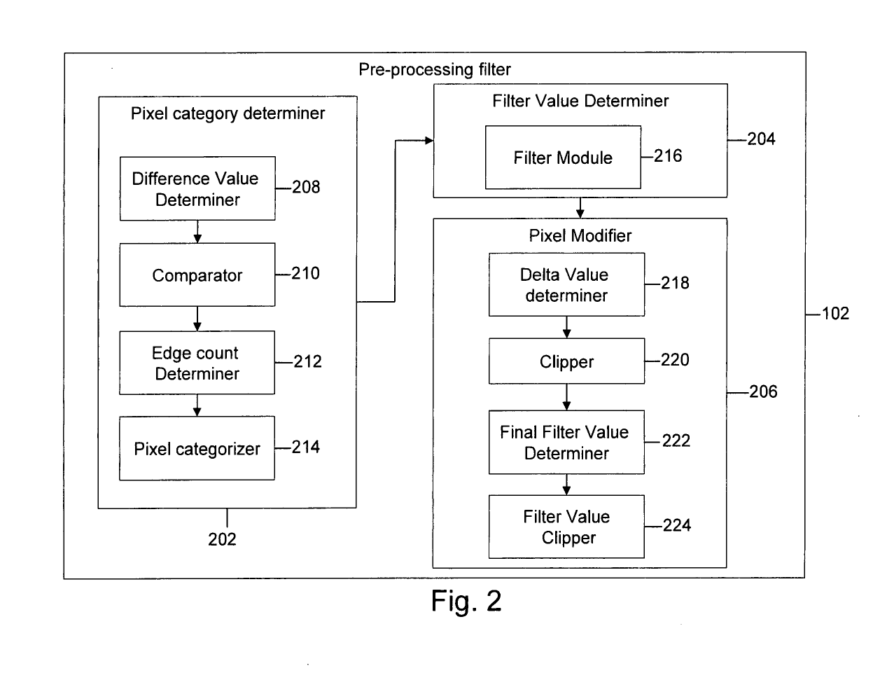

The filtered image is input into standardized encoder 104 to obtain a compressed bit stream. Standardized encoder 104 encodes the filtered image according to various international standards. Examples of international standards include, but are not limited to, H.263, H.264, MPEG2 and MPEG4. Pre-processing filter 102 includes various modules for filtering the image. Pre-processing filter 102 with various modules has been explained in detail in conjunction with FIG. 2.

FIG. 2 is a block diagram of pre-processing filter 102 in accordance with an embodiment of the invention. Pre-processing filter 102 includes a pixel category determiner 202, a filter value determiner 204 and a pixel modifier 206. Pixel category determiner 202 includes a difference value determiner 208, a comparator 210, an edge count determiner 212, and a pixel categorizer 214. Filter value determiner 204 includes a filter module 216. Pixel modifier 206 includes a delta value determiner 218, a clipper 220, a final filter value determiner 222, and a filter value clipper 224.

Pixel category determiner 202 receives an image including a plurality of pixels and determines a category for each of the plurality of pixels. Difference value determiner 208 determines one or more difference values of a pixel parameter, between each of the plurality of pixels and one or more neighboring pixels corresponding to each of the plurality of pixels. In an embodiment of the present invention, a neighboring window includes the pixel and one or more neighboring pixels surrounding the pixel. The neighboring window is an N×N pixel window, where N is an odd natural number. Difference value determiner 208 provides the one or more difference values to comparator 210.

Comparator 210 compares the one or more difference values with a predetermined threshold value of the pixel parameter. Comparator 210, thereafter, provides the results to edge count determiner 212. Edge count determiner 212 determines an edge count based on the one or more difference values. Edge count determiner 212 provides the edge count to pixel categorizer 214. Pixel categorizer 214 categorizes each of the plurality of pixels based on the edge count.

Pixel category determiner 202 provides filter value determiner 204 with the pixel category. Subsequently, filter value determiner 204 determines a filter value for each of the plurality of pixels. Filter module 216 filters each of the plurality of pixels based on their categories.

Further, pixel modifier 206 modifies each of the plurality of pixels filtered by filter module 216. In pixel modifier 206, delta value determiner 218 determines a delta value for each of the plurality of pixels, between the pixel parameter of each of the plurality of pixels and the filter value for each of the plurality of pixels. Delta value determiner 218 provides the delta values to clipper 220. Clipper 220 delimits the delta value for each of the plurality of pixels between a predetermined maximum delta value and a predetermined minimum delta value. Final filter value determiner 222 determines a final filter value for each of the plurality of pixels by subtracting the delta value for each of the plurality of pixels from the pixel parameter of each of the plurality of pixels. Finally, filter value clipper 224 delimits the final filter value for each of the plurality of pixels between a predetermined maximum pixel parameter value and a predetermined minimum pixel parameter value.

In an embodiment of the invention, the filtering of each of the plurality of pixels and the categorization of the remaining pixels is performed in parallel by pre-processing filter 102.

In an embodiment of the invention, the neighboring window is used for determining the category for each of the plurality of pixels.

In an embodiment of the invention, luminance is the pixel parameter. In another embodiment of the invention, a pixel parameter may be chrominance or color.

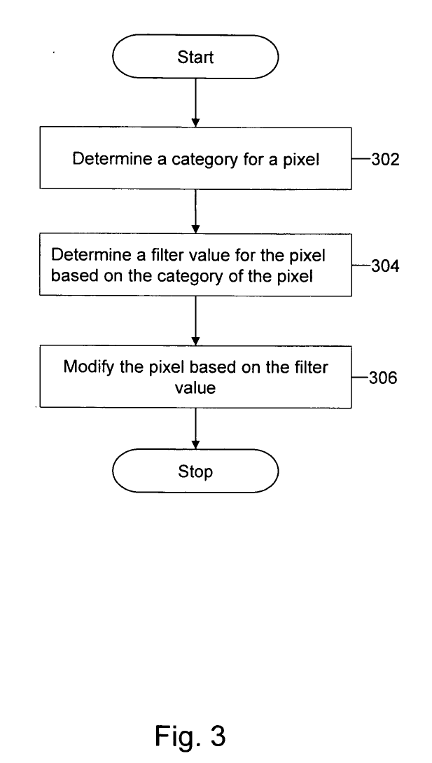

FIG. 3 is a flowchart, illustrating a method for filtering an image in accordance with various embodiment of the invention. At step 302, a category is determined for each of a plurality of pixels of an image. A neighboring window is used for determining the category for each of the plurality of pixels. The neighboring window is an N×N pixel window, where N is an odd natural number.

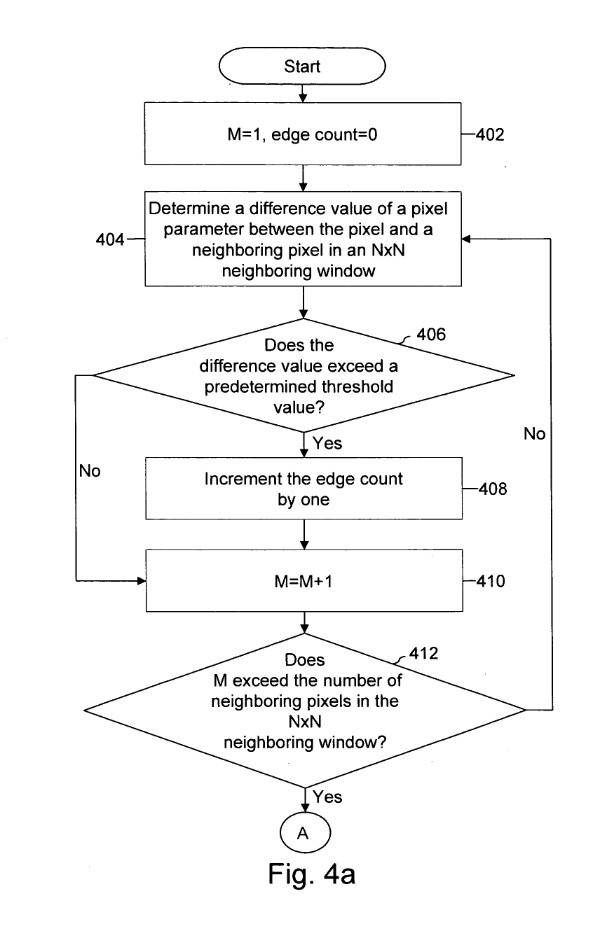

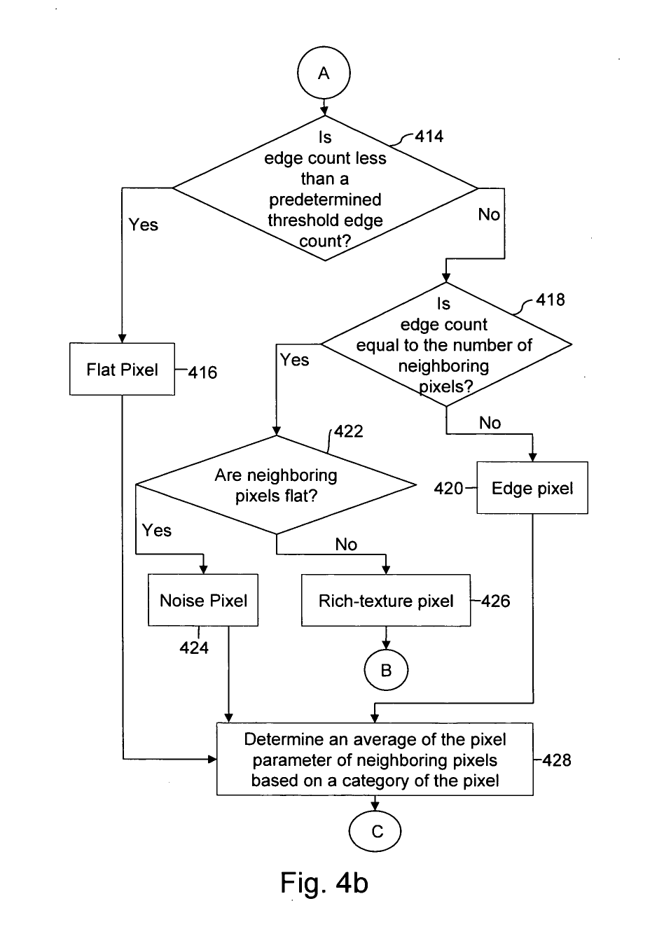

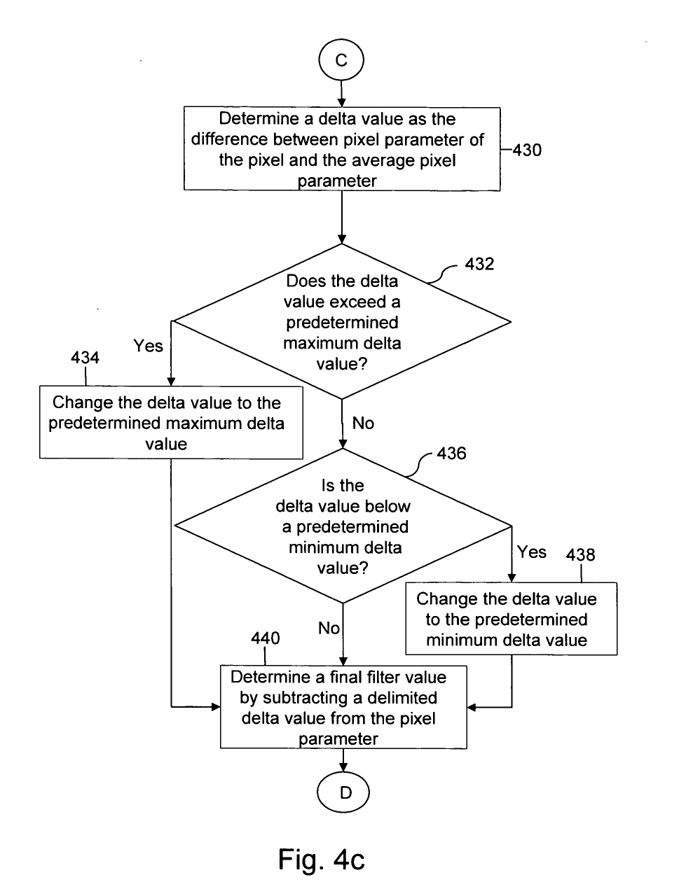

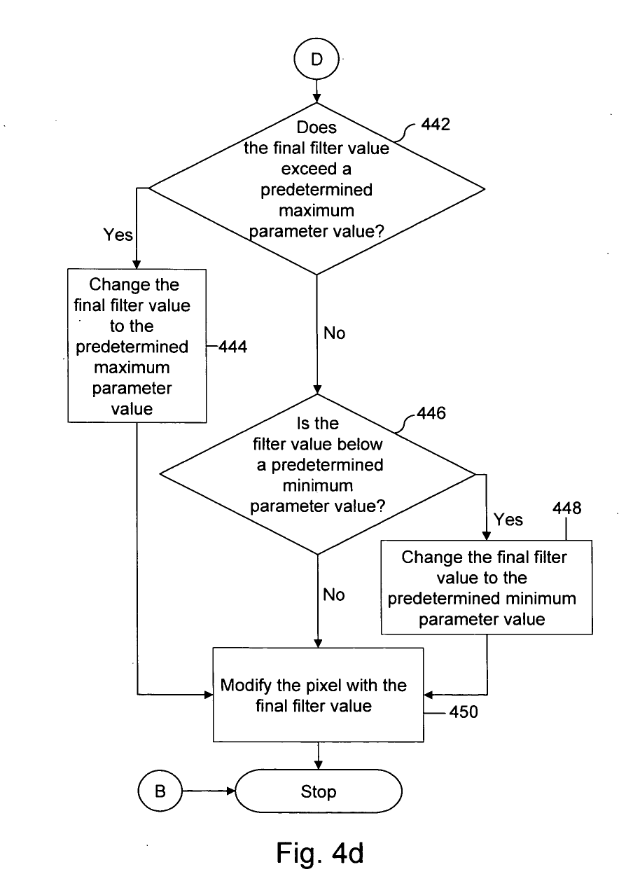

Thereafter, at step 304, a filter value for each of the plurality of pixels is determined. The filter value is determined based on the category of each of the plurality of pixels. At step 306, a final filter value for each of the plurality of pixels is determined based on their respective filter values and each of the plurality of pixels is modified by using their respective final filter values. The method detailed in FIG. 3 is performed for each of the plurality of pixels of the image to obtain a filtered image. The determination of a category and a filter value for each of the plurality of pixels, and modification of each of the plurality of pixels is explained in detail in conjunction with FIGS. 4a, 4b, 4c and 4d.

FIGS. 4a, 4b, 4c and 4d depict a flowchart, illustrating a method for filtering a pixel of an image, in accordance with an embodiment of the invention. At step 402, a counter M and an edge count are initialized for categorizing the pixels of the image. Both M and edge count are natural numbers.

At step 404, a difference value between the pixel and a neighboring pixel is determined. A neighboring window includes the pixel and the neighboring pixels. The neighboring pixels include all the pixels surrounding the pixel in the neighboring window. The neighboring window is an N×N pixel window, N being an odd natural number. N is selected in such a way that the number of neighboring pixels on each side of the pixel is equal. Let

$$HN = \frac{N - 1}{2} ,$$

where HN is the length of one side of the neighboring window. The difference value is being determined for a pixel parameter. The pixel parameter is the characteristic feature of the pixel, such as luminance, chrominance and the like. The difference value is determined by using equation (1).

DIFF(k+HN,l+HN)=ABS((I(i,j)−I(i+k,j+l)), where −HN≦k,l≦HN and (k,l)≠(0,0) (1)

Here I(i,j) is a pixel parameter value for the pixel to be filtered.

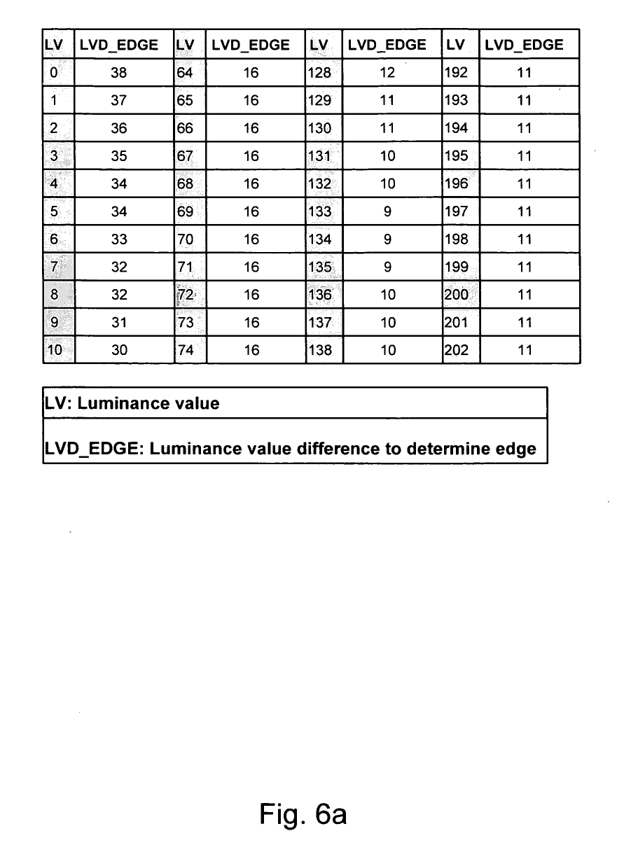

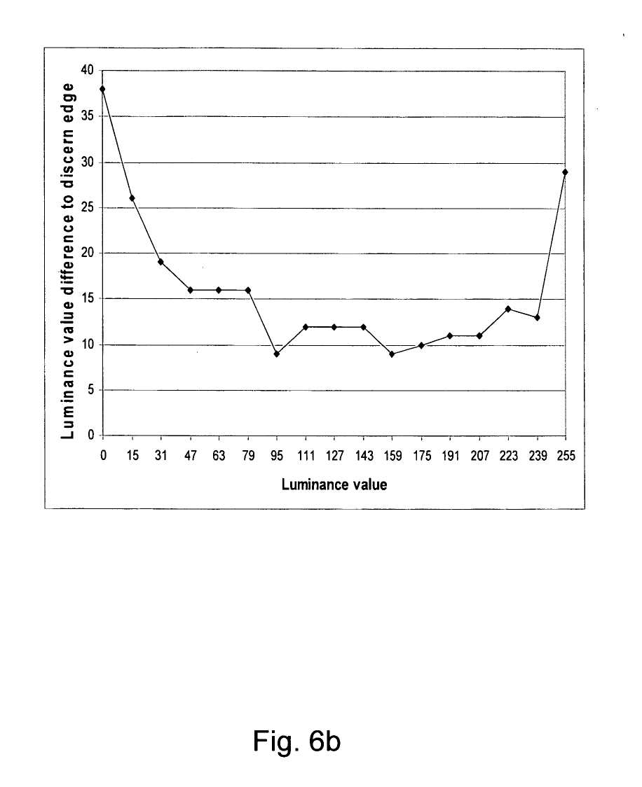

Thereafter, at step 406, the difference value determined is compared with a predetermined threshold value. In an embodiment of the invention, the predetermined threshold value is a function of the luminance of the pixel and is determined experimentally. In an embodiment of the invention, the predetermined threshold value is the minimum difference of the luminance desired for a human eye to identify existence of an edge. The predetermined threshold value is obtained from human vision thresholds for edge detection (HVTED) table explained in detail in conjunction with FIGS. 6a, 6b and 6c. If the difference value exceeds the predetermined threshold value then step 408 is performed.

At step 408, the edge count is incremented by one if the difference value exceeds the predetermined threshold value. The edge count (EC) is determined by using equation (2).

$$EC = {\sum }_{k = - HN}^{HN} {\sum }_{l = - HN}^{HN} ( ( Diff ( k + HN , l + HN ) > HVTED ( I ( i , j ) ) ? 1 \text{:} 0 ) \\ where ( k , l ) \neq ( 0 , 0 ) \qquad ( 2 )$$

Here HVTED(I(i,j)) is the predetermined threshold value.

If the difference value does not exceed the predetermined threshold value then step 410 is performed. At step 410, counter M is incremented by one. Thereafter, at step 412, the value of counter M is compared with the number of neighboring pixels. The number of neighboring pixels is determined by subtracting one from the total number of pixels (N×N) in the neighboring window. If the value of counter M does not exceed the number of neighboring pixels then steps 404 to 410 are performed. Steps 404 to 410 are performed for each of the neighboring pixels in the neighboring window to obtain a final value for the edge count for the pixel. The final value of the edge count is used to determine the category for the pixel.

At step 412, if the value of counter M exceeds the number of neighboring pixels then step 414 is performed. At step 414, the final value of the edge count is checked against a predetermined threshold. The predetermined threshold is N for the N×N pixel neighboring window, where N is an odd number. If the final value of the edge count is less than the predetermined threshold then step 416 is followed. At step 416, the category of the pixel is determined as a ‘flat pixel’.

If the final value of the edge count is greater than the predetermined threshold then step 418 is followed. At step 418, the final value of the edge count is compared with the number of neighboring pixels. The number of neighboring pixels is determined by subtracting one from the total number of pixels (N×N) in the neighboring window. If the final value of the edge count is not equal to the number of neighboring pixels then at step 420, the category of the pixel is classified as an ‘edge pixel’.

If the final value of the edge count is equal to the number of neighboring pixels then step 422 is performed. At step 422, a check is performed to determine whether the neighboring pixels are ‘flat’. The check is performed by determining the difference between a minimum pixel luminance (MINPL) and a maximum pixel luminance (MAXPL) and comparing the difference against a predetermined threshold, which equals to twice of HVTED used in step 406. The MINPL and the MAXPL are the minimum and the maximum luminance values, respectively, for the pixels in the neighboring window. The MINPL is determined by using equation (3).

MINPL=min{I(i+k,j+l), where −HN≦k,l≦HN} (3)

The MAXPL is determined by using equation (4).

MAXPL=max{I(i+k, j+l),where −HN≦k,l≦HN} (4)

If the difference of the maximum luminance value and minimum luminance value does not exceed the predetermined threshold, that is,

MAXPL−MINPL<2×HVTED(I(i,j)) (5),

then the neighboring pixels are ‘flat pixels’ and step 424 is performed. At step 424, the category of the current pixel is determined as a ‘noise pixel’.

If the difference of the MINPL and MAXPL exceeds the predetermined threshold, that is, MAXPL−MINPL≧2×HVTED(I(i,j)), then the neighboring pixels are not ‘flat pixels’ and subsequently, step 426 is performed. At step 426, the category of the current pixel is determined as a ‘rich texture pixel’.

Thereafter, at step 428, an average value of the pixel parameter of the neighboring pixels is determined based on the category of the pixel. If the pixel is categorized as the ‘edge pixel’ then an average value is determined for the neighboring pixels for which the difference values for the pixel parameter exceeds the predetermined threshold value of the pixel parameter. The difference value is determined between the pixel and the neighboring pixels. The average value is termed as the filter value of the pixel. The filter value is used for filtering the pixel. Equations 6, 7 and 8 are used to determine the filter value for the pixel when the category of the pixel is determined as the ‘edge pixel’.

$$\begin{matrix}Edge pixel sum = {\sum }_{k = - HN}^{HN} {\sum }_{l = - HN}^{HN} ( ( Diff ( k + HN , l + HN ) > HVTED ( I ( i , j ) ) ) ? I ( i + k , j + l ) \text{:} 0 ) , \\ where ( k , l ) \neq ( 0 , 0 ) & ( 6 ) \\ Edge pixel count = {\sum }_{k = - HN}^{HN} {\sum }_{l = - HN}^{HN} ( ( Diff ( k + HN , l + HN ) > HVTED ( I ( i , j ) ) ) ? 1 \text{:} 0 ) , \\ where ( k , l ) \neq ( 0 , 0 ) , and & ( 7 ) \\ Filter value ( edge ) = Edge pixel sum \text{/} Edge pixel count & ( 8 )\end{matrix}$$

If the pixel is categorized as the ‘flat pixel’ then an average value is determined for the neighboring pixels for which the difference values for the pixel parameter do not exceed the predetermined threshold value of the pixel parameter. The difference value is determined between the pixel and the neighboring pixels. The average value is termed as the filter value of the pixel. The filter value is used for filtering the pixel. Equations 9, 10 and 11 are used to determine the filter value for the pixel when the category of the pixel is determined as the ‘flat pixel’.

$$\begin{matrix}Edge pixel sum = {\sum }_{k = - HN}^{HN} {\sum }_{l = - HN}^{HN} ( ( Diff ( k + HN , l + HN ) > HVTED ( I ( i , j ) ) ) ? 0 \text{:} I ( i + k , j + l ) ) , \\ where ( k , l ) \neq ( 0 , 0 ) & ( 9 ) \\ Flat pixel count = {\sum }_{k = - HN}^{HN} {\sum }_{l = - HN}^{HN} ( ( Diff ( k + HN , l + HN ) > HVTED ( I ( i , j ) ) ) ? 0 \text{:} 1 ) , \\ where ( k , l ) \neq ( 0 , 0 ) , and & ( 10 ) \\ Filter value ( flat ) = Flat pixel sum \text{/} Flat pixel count & ( 11 )\end{matrix}$$

If the pixel is categorized as the ‘noise pixel’ then an average value of the pixel parameter is determined for all the neighboring pixels. The average value is termed as the filter value of the pixel which is used for filtering the pixel. Equations 12, 13 and 14 are used to determine the filter value for the pixel when the category of the pixel is determined as the ‘noise pixel’.

$$\begin{matrix}Noise pixel sum = {\sum }_{k = - HN}^{HN} {\sum }_{l = - HN}^{HN} I ( i + k , j + l ) , \\ where ( k , l ) \neq ( 0 , 0 ) , & ( 12 ) \\ Noise pixel count = {N}^{2} - 1 & ( 13 ) \\ Filter value ( noise ) = Noise pixel sum \text{/} Noise pixel count & ( 14 )\end{matrix}$$

At step 430, a delta value for the pixel is determined by subtracting the filter value from the pixel parameter value of the pixel. An equation from equations 15, 16 and 17 is used to determine the delta value for the pixel, based on the category of the pixel.

Delta value (flat)=Pixel parameter value (flat)−Filter value (flat) (15)

Delta value (edge)=Pixel parameter value (edge)−Filter value (edge) (16)

Delta value (noise)=Pixel parameter value (noise)−Filter value (noise) (17)

Thereafter, at step 432, the delta value for the pixel is compared with the predetermined maximum delta value. The predetermined maximum delta value is obtained from the HVTED table explained in detail in conjunction with FIGS. 6a, 6b and 6c. If the delta value for the pixel exceeds the predetermined maximum delta value then step 434 is performed.

At step 434, the delta value is delimited to the predetermined maximum delta value. The changed delta value for the pixel is termed as a first delimited delta value for the pixel. If the delta value for the pixel does not exceed the predetermined maximum delta value then step 436 is performed. At step 436, the delta value is compared with a predetermined minimum delta value. The predetermined minimum delta value is obtained from the HVTED table. If the delta value for the pixel is not below the predetermined minimum delta value then the delta value is termed as a second delimited delta value for the pixel.

If the delta value for the pixel is below the predetermined minimum delta value then step 438 is performed. At step 438, the delta value is changed to the predetermined minimum delta value. The changed delta value for the pixel is termed as a third delimited delta value for the pixel. Any one equation from equations 18, 19 and 20 is used to determine the delimited value for the pixel based on the category of the pixel.

Delimited delta value (flat)=clip(−HVTED(I(i,j)),HVTED(I(i,j)),delta value (flat)) (18)

Delimited delta value (edge)=clip(−HVTED(I(i,j))>>1,HVTED(I(i,j))>>1, delta value (edge)) (19)

Delimited delta value (noise)=clip(−HVTED(I(i,j))<<1,HVTED(I(i,j))<<1,delta value(noise)) (20)

where clip(a,b,c)=(c<a)?a:(c>b?b:c)

Thereafter, at step 440, a final filter value for the pixel is determined by subtracting the delimited delta value for the pixel from the pixel parameter value of the pixel. The final filter value for the pixel is determined by using any one equation from equations 21, 22 and 23 based on the category. The pixels categorized as ‘rich texture pixel’ are not filtered.

Final filter value (flat)=Pixel parameter value (flat)−Delta value (flat) (21)

Final filter value (edge)=Pixel parameter value (edge)−Delta value (edge) (22)

Final filter value (noise)=Pixel parameter value (noise)−Delta value (noise) (23)

At step 442, the final filter value for the pixel is compared with a predetermined maximum pixel parameter value, which is decided by the bit depth of the input image. In an embodiment of the invention, if the image bit depth is 8, the maximum pixel parameter value is 255. If the final filter value for the pixel exceeds the predetermined maximum pixel parameter value then step 444 is performed.

At step 444, the final filter value is changed to the predetermined maximum pixel parameter value. The changed final filter value for the pixel is termed as a first delimited final filter value for the pixel. If the final filter value for the pixel does not exceed the predetermined maximum pixel parameter value then step 446 is performed. At step 446, the final filter value for the pixel is compared with a predetermined minimum pixel parameter value. In an embodiment of the invention, the minimum pixel parameter value is 0. If the final filter value for the pixel is not below the predetermined minimum value then the final filter value for the pixel is termed as a second delimited final filter value for the pixel.

If the final filter value for the pixel is below the predetermined minimum value then step 448 is performed. At step 448, the final filter value for the pixel is changed to the predetermined minimum pixel parameter value. The changed final filter value for the pixel is termed as a third delimited final filter value for the pixel. The first, second and third delimited final filter value are hereinafter referred to as a delimited final filter value.

Thereafter, at step 450, the pixel is modified by using the delimited final filter value for the pixel. An equation from equations 24, 25 and 26 is used to determine the delimited final filter value based on the category of the pixel.

Delimited final filter value (flat)=clip (predetermined minimum pixel parameter value, predetermined minimum pixel parameter value, final filter value (flat)) (24)

Delimited final filter value (edge)=clip (predetermined minimum pixel parameter value, predetermined minimum pixel parameter value, final filter value (edge)) (25)

Delimited final filter value (noise)=clip (predetermined minimum pixel parameter value, predetermined minimum pixel parameter value, final filter value (noise)) (26)

The modified pixel is then saved into a memory. If the category for the pixel is determined as the ‘rich texture pixel’ then the pixel is not filtered and modified. The pixel is then directly saved into the memory. The method detailed in FIGS. 4a, 4b, 4c and 4d is performed for each of the plurality of pixels of the image to obtain a filtered image.

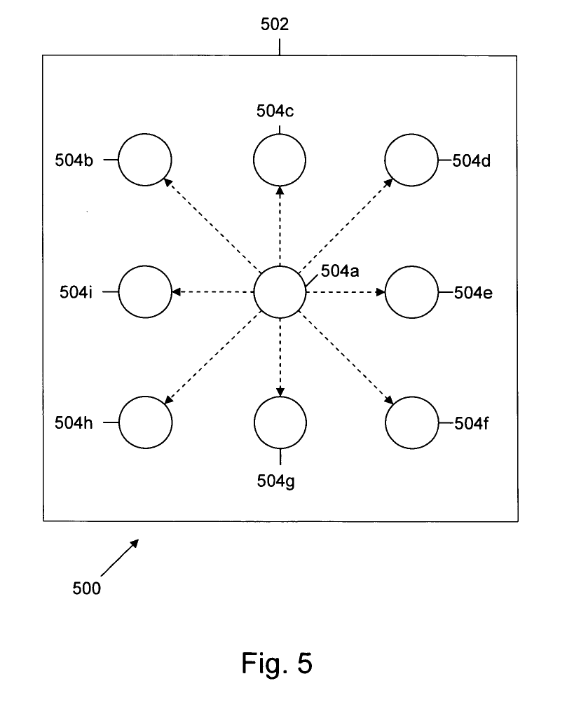

FIG. 5 illustrates an exemplary embodiment of a method for filtering a pixel in a 3×3 neighboring window 502 of an image, in accordance with an embodiment of the invention. An image including a plurality of pixels, such as a plurality of pixels 504a, 504b, 504c, 504d, 504e, 504f, 504g, 504h, and 504i, is input into a pre-processing filter. A pixel, such as pixel 504a, is selected from the plurality of pixels. 3×3 neighboring window 502 including pixel 504a and the neighboring pixels, such as pixels 504b, 504c, 504d, 504e, 504f, 504g, 504h, and 504i, surrounding pixel 504a is used to decide a category for pixel 504a. Pixels 504b, 504c, 504d, 504e, 504f, 504g, 504h, and 504i are hereinafter referred to as neighboring pixels 504. The number of neighboring pixels 504 in 3×3 neighboring window 502 is eight. Eight difference values for a pixel parameter are determined for the eight neighboring pixels 504 in 3×3 neighboring window 502. The pixel parameter is luminance. The eight difference values are determined by subtracting the luminance value of pixel 504a from the luminance values of each of neighboring pixels 504. The difference values are then compared with a predetermined threshold value of the luminance. The predetermined threshold value is determined from the HVTED table explained in detail in conjunction with FIGS. 6a, 6b and 6c. Initially, an edge count equal to zero is considered. Each time a difference value exceeds the predetermined threshold value the edge count is incremented by one. For example, if five difference values exceed the predetermined threshold value then the edge count is five.

A category for pixel 504a is then determined based on the edge count. If the edge count is less than a predetermined threshold edge count then the category for pixel 504a is determined as a ‘flat pixel’. The predetermined threshold edge count is 3 for 3×3 neighboring window 502. If the edge count is not less than 3 and is not equal to 8 (3×3−1), the category for pixel 504a is determined as an ‘edge pixel’. If edge count equals 8, the category for pixel 504a may be determined either as a ‘rich texture pixel’ or as a ‘noise pixel’. The category for pixel 504a is then determined by checking if neighboring pixels 504 are flat. The check is performed by determining a difference between the maximum luminance value and the minimum luminance value in 3×3 neighboring window 502 and comparing the difference with a predetermined maximum value. The predetermined maximum value is a function of the predetermined threshold value used for the eight difference values and is determined experimentally. If the difference exceeds the predetermined maximum value, the category for pixel 504a is then determined as a ‘rich texture pixel’. If the edge count equals 8 and the difference between the maximum luminance value and the minimum luminance value in 3×3 neighboring window 502 does not exceed the predetermined maximum value, the category for pixel 504a is determined as a ‘noise pixel’.

Thereafter, a filter value is determined for pixel 504a based on the category of pixel 504a. If the category is ‘flat pixel’, pixel 504a is filtered with the filter value equal to the average luminance value of neighboring pixels 504. The difference values of neighboring pixels 504 are less than the predetermined threshold value of the luminance. The difference value is the difference between the luminance of pixel 504a and the luminance of neighboring pixel 504. For example, in an embodiment of the present invention, if there are five neighboring pixels, for which the respective difference value is less than the predetermined threshold value of the luminance, the filter value will be equal to the average of the luminance values of the five neighboring pixels.

If the category is ‘edge pixel’, pixel 504a is filtered with filter value equal to the average luminance value of neighboring pixels 504, for which the difference values exceed the predetermined threshold value of the luminance. If the category is ‘noise pixel’, pixel 504a is filtered with filter value equal to the average luminance value of all neighboring pixels 504. The pixels categorized as ‘rich texture pixel’ are not filtered.

Thereafter, the filter value is subtracted from the luminance value of pixel 504a in order to determine a delta value. The delta value is then delimited between a predetermined maximum delta value and a predetermined minimum delta value. Thereafter, the final filter value is determined by subtracting the delimited delta value from the luminance value of pixel 504a. Finally, the final filter value is delimited between a predetermined maximum pixel parameter value and a minimum pixel parameter value, in terms of the bit depth of input image.

FIGS. 6a and 6b is an exemplary table and an exemplary graph illustrating thresholds for edge detection, in accordance with various embodiments of the invention. The Human Vision-Based Threshold for Edge Detection (HVTED) table is obtained based on experimental results. In an embodiment of the invention, the HVTED table is obtained by human vision test. In the HVTED table, the luminance value ranges between the predetermined maximum pixel parameter value, 255, and minimum pixel parameter value, 0. The HVTED table further provides the luminance value differences corresponding to the luminance values for determining an edge. FIG. 6b provides an exemplary graphical representation of the variation of the luminance value differences corresponding to the luminance values in the range defined for the HVTED table.

The computer program product of the invention is executable on a computer system for causing the computer system to perform a method of filtering an image including an image filtering method of the present invention. The computer system includes a microprocessor, an input device, a display unit and an interface to the Internet. The microprocessor is connected to a communication bus. The computer also includes a memory. The memory may include Random Access Memory (RAM) and Read Only Memory (ROM). The computer system further includes a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The set of instructions may be a program instruction means. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

Further, the entire system in accordance with the invention may be implemented in a single Field-Programmable Gate Array (FPGA), Digital Signal Processor (DSP) and so forth.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

Furthermore, throughout this specification (including the claims if present), unless the context requires otherwise, the word “comprise”, or variations such as “comprises” or “comprising”, will be understood to imply the inclusion of a stated element or group of elements but not the exclusion of any other element or group of elements. The word “include,” or variations such as “includes” or “including,” will be understood to imply the inclusion of a stated element or group of elements but not the exclusion of any other element or group of elements. Claims that do not contain the terms “means for” and “step for” are not intended to be construed under 35 U.S.C. §112, paragraph 6.

What is claimed is:

1. A method for filtering an image, the image comprising a plurality of pixels, the method comprising:
a. determining a category for each of the plurality of pixels;
b. determining a filter value for each of the plurality of pixels based on the category of each of the plurality of pixels; and
c. modifying each of the plurality of pixels based on the filter value of each of the plurality of pixels.

2. The method according to claim 1, wherein determining the category for each of the plurality of pixels comprises determining one or more difference values of a pixel parameter, wherein the one or more difference values are determined between each of the plurality of pixels and one or more neighboring pixels.

3. The method according to claim 2, wherein the one or more neighboring pixels are located in a neighboring window in the image.

4. The method according to claim 2, wherein determining the category for each of the plurality of pixels further comprises comparing the one or more difference values with a predetermined threshold value of the pixel parameter.

5. The method according to claim 2, wherein determining the category for each of the plurality of pixels further comprises determining an edge count based on the one or more difference values.

6. The method according to claim 5, wherein the category for each of the plurality of pixels is determined based on the edge count.

7. The method according to claim 1, wherein determining the filter value for each of the plurality of pixels comprises filtering of each of the plurality of pixels.

8. The method according to claim 1, wherein modifying each of the plurality of pixels comprises determining a delta value for each of the plurality of pixels, wherein the delta value for each of the plurality of pixels is the difference between the pixel parameter of each of the plurality of pixels and the filter value.

9. The method according to claim 8, wherein modifying each of the plurality of pixels further comprises determining a delimited delta value for each of the plurality of pixels, wherein the delimited delta value for each of the plurality of pixels is determined by delimiting the delta value for each of the plurality of pixels between a predetermined maximum delta value and a predetermined minimum delta value.

10. The method according to claim 9, wherein modifying each of the plurality of pixels further comprises determining a final filter value for each of the plurality of pixels, wherein the final filter value for each of the plurality of pixels is determined by subtracting the delimited delta value for each of the plurality of pixels from the pixel parameter of each of the plurality of pixels.

11. The method according to claim 10, wherein modifying each of the plurality of pixels further comprises delimiting the final filter value for each of the plurality of pixels between a predetermined maximum pixel parameter value and a predetermined minimum pixel parameter value.

12. A system for filtering an image, the image comprising a plurality of pixels, the system comprising:
a. a pixel category determiner, the pixel category determiner determining a category for each of the plurality of pixels;
b. a filter value determiner, the filter value determiner determining a filter value for each of the plurality of pixels based on the category of each of the plurality of pixels; and
c. a pixel modifier, the pixel modifier modifying each of the plurality of pixels based on the filter value of each of the plurality of pixels.

13. The system according to claim 12, wherein the pixel category determiner comprises a difference value determiner, the difference value determiner determining one or more difference values of a pixel parameter, wherein the one or more difference values are determined between each of the plurality of pixels and one or more neighboring pixels.

14. The system according to claim 13, wherein the pixel category determiner further comprises a comparator, the comparator comparing the one or more difference values with a predetermined threshold value of the pixel parameter.

15. The system according to claim 13, wherein the pixel category determiner further comprises an edge count determiner, the edge count determiner determining an edge count based on the one or more difference values.

16. The system according to claim 15, wherein the pixel category determiner further comprises a pixel categorizer, the pixel categorizer categorizing each of the plurality of pixels based on the edge count.

17. The system according to claim 12, wherein the filter value determiner comprises a filtering module for filtering of each of the plurality of pixels.

18. The system according to claim 12, wherein the pixel modifier comprises a delta value determiner, the delta value determiner determining a delta value for each of the plurality of pixels, wherein the delta value for each of the plurality of pixels is a difference between the pixel parameter of each of the plurality of pixels and the filter value for each of the plurality of pixels.

19. The system according to claim 18, wherein the pixel modifier further comprises a clipper, the clipper delimiting the delta value for each of the plurality of pixels between a predetermined maximum delta value and a predetermined minimum delta value.

20. The system according to claim 19, wherein the pixel modifier further comprises a final filter value determiner, the final filter value determiner determining a final filter value for each of the plurality of pixels by subtracting the delta value for each of the plurality of pixels from the pixel parameter of each of the plurality of pixels.

21. The system according to claim 20, wherein the pixel modifier further comprises a filter value clipper, the filter value clipper delimiting the final filter value for each of the plurality of pixels between a predetermined maximum pixel parameter value and a predetermined minimum pixel parameter value.

22. A computer program product, the computer program product comprising a computer usable medium having a computer readable program code embodied therein for filtering an image, the image comprising a plurality of pixels, the computer readable program code performing:
a. determining a category for each of the plurality of pixels;
b. determining a filter value for each of the plurality of pixels based on the category of each of the plurality of pixels; and
c. modifying each of the plurality of pixels based on the filter value of each of the plurality of pixels.

23. The computer program product according to claim 22, wherein the computer readable program code for determining the category for each of the plurality of pixels performs determining one or more difference values of a pixel parameter, wherein the one or more difference values are determined between each of the plurality of pixels and one or more neighboring pixels.

24. The computer program product according to claim 23, wherein the computer readable program code for determining the category for each of the plurality of pixels further performs comparing the one or more difference values with a predetermined threshold value of the pixel parameter.

25. The computer program product according to claim 23, wherein the computer readable program code for determining the category for each of the plurality of pixels further performs determining an edge count based on the one or more difference values.

26. The computer program product according to claim 25, wherein the computer readable program code for determining the category for each of the plurality of pixels further performs determining the category for each of the plurality of pixels based on the edge count.

27. The computer program product according to claim 22, wherein the computer readable program code for determining the filter value for each of the plurality of pixels performs filtration of each of the plurality of pixels.

28. The computer program product according to claim 27, wherein the computer readable program code for modifying each of the plurality of pixels determines a delta value for each of the plurality of pixels, wherein the delta value for each of the plurality of pixels is a difference between a pixel parameter of each of the plurality of pixels and the filter value for each of the plurality of pixels.

29. The computer program product according to claim 28, wherein the computer readable program code for modifying each of the plurality of pixels further determines a delimited delta value for each of the plurality of pixels, wherein the delimited delta value for each of the plurality of pixels is determined by delimiting the delta value for each of the plurality of pixels between a predetermined maximum delta value and a predetermined minimum delta value.

30. The computer program product according to claim 29, wherein the computer readable program code for modifying each of the plurality of pixels further performs determining a final filter value for each of the plurality of pixels, wherein the final filter value for each of the plurality of pixels is determined by subtracting the delimited delta value for each of the plurality of pixels from the pixel parameter of each of the plurality of pixels.

31. The computer program product according to claim 30, wherein the computer readable program code for modifying each of the plurality of pixels further performs delimiting the final filter value for each of the plurality of pixels between a predetermined maximum pixel parameter value and a predetermined minimum pixel parameter value.
